(19) United States
(12) Patent Application Publication
(10) Pub. No.: US 2017/0185673 A1
(43) Pub. Date: Jun. 29, 2017

(54) Method and Electronic Device for QUERY RECOMMENDATION

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Hongbin LIU, Beijing (CN); Tielong GUO, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/242,057

(22) Filed: Aug. 19, 2016

Related U.S. Application Data
(63) Continuation of application No. PCT/CN2016/089280, filed on Jul. 7, 2016.

(30) Foreign Application Priority Data
Dec. 25, 2015 (CN) 201510994506.3

(51) Int. Cl. G06F 17/30

(52) U.S. Cl. CPC G06F 17/30696; G06F 17/30705; G06F 17/30675

(57) ABSTRACT

The present disclosure relates to a method and electronic device for query recommendation, comprising: acquiring a history query statement inputted by a preset user; performing statement analysis on the history query statement to obtain statement information of the history query statement; determining data table entry information queried by the history query statement according to the statement information, determining a cluster label corresponding to the preset user according to the data table entry information; determining a recommended query object corresponding to the preset user according to cluster labels corresponding to a plurality of history query statements; and generating a recommended query statement corresponding to the recommend query object. The inputting efficiency of query statements is raised, and correspondingly, the efficiency of data query is also improved.

### CROSS REFERENCE TO RELATED APPLICATION

The present application is a continuation of a PCT application No. PCT/CN2016/089280 filed on Jul. 7, 2016, and claims priority to Chinese Patent Application No. 201510994506.3 titled as “METHOD AND DEVICE FOR QUERY RECOMMENDATION”, filed with State Intellectual Property Office of China on Dec. 25, 2015, which is incorporated herein by reference in its entirety.

### FIELD OF TECHNOLOGY

The present disclosure relates to the field of data processing, and in particular, to a method and electronic device for query recommendation.

### BACKGROUND

When a data query is performed on a relational database, it is required to utilize database query language, such as Structured Query Language (called as SQL for short) to conduct the corresponding data query.

At present, when utilizing database query language to conduct a data query, a technician needs to input a query language every time he queries data table, and needs to type each character one by one every time he inputs the query language, leading to great inconvenience in operation. Thus, when a user conducts a query, it will take very long time to operate, thereby reducing efficiency.

Some database can display latest history query statements inputted by the user in a menu form when the user clicks a query data frame in query, so that the user may select one or more from the history query statements and then make some amendments to them. Although in such a way, a speed of inputting characters in query can be accelerated, the user may still need to edit and adjust history commands every time he queries new content due to the history query statements all he faces, thus the efficiency is still lower.

### SUMMARY

To overcome the problem existing in the related art, the present disclosure may provide a method and electronic device for query recommendation.

According to a first aspect of the embodiments of the present disclosure, a method for query recommendation may be provided, including:

acquiring a history query statement inputted by a preset user;
performing statement analysis on the history query statement to obtain statement information of the history query statement;
determining data table entry information to be queried by the history query statement according to the statement information, wherein the data table entry information includes: a query object, a flag of a data table where the query object is located, and attribute information of the query object in the data table;
determining a cluster label corresponding to the preset user according to the data table entry information;
determining a recommended query object corresponding to the preset user according to cluster labels corresponding to a plurality of history query statements; and
generating a recommended query statement corresponding to the recommended query object.

According to a second aspect of the embodiments of the present disclosure, a non-volatile computer readable storage medium may be provided, which is stored with computer executable instructions configured for:

acquiring a history query statement inputted by a preset user;
performing statement analysis on the history query statement to obtain statement information of the history query statement;
determining data table entry information to be queried by the history query statement according to the statement information, wherein the data table entry information includes: a query object, a flag of a data table where the query object is located, and attribute information of the query object in the data table;
determining a cluster label corresponding to the preset user according to the data table entry information;
determining a recommended query object corresponding to the preset user according to cluster labels corresponding to a plurality of history query statements; and
generating a recommended query statement corresponding to the recommended query object.

According to a third aspect of the embodiments of the present disclosure, an electronic device for query recommendation may be provided, including:

at least one processor; and
a memory, communicatively connected with the at least one processor;
wherein, the memory is stored with instructions executable by the at least one processor, which when executed by the at least one processor, cause the at least one processor to:
acquire a history query statement inputted by a preset user;
perform statement analysis on the history query statement to obtain statement information of the history query statement;
determine data table entry information queried by the history query statement according to the statement information, wherein the data table entry information includes: a query object, a flag of a data table where the query object is located, and attribute information of the query object in the data table;
determine a cluster label corresponding to the preset user according to the data table entry information;
determine a recommended query object corresponding to the preset user according to cluster labels corresponding to a plurality of history query statements; and
generate a recommended query statement corresponding to the recommended query object.

It should be understood that, the above general description and any detailed description illustrated hereinafter are merely exemplary and explanatory, rather than limiting to the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a method for query recommendation provided according to an exemplary embodiment;

FIG. 2 is a schematic flowchart illustrating step S102 in FIG. 1;

FIG. 3 is a schematic diagram of structure illustrating a first syntax tree provided according to the embodiments of the present disclosure;

FIG. 4 is a schematic flowchart illustrating step S105 in FIG. 1;

FIG. 5 is another schematic flowchart illustrating step S105 in FIG. 1;

FIG. 6 is a flowchart illustrating another method for query recommendation provided according to an exemplary embodiment;

FIG. 7 is a schematic diagram of structure illustrating a device for query recommendation provided according to an exemplary embodiment;

FIG. 8 is a schematic diagram of structure illustrating a statement analyzing module in FIG. 7;

FIG. 9 is a schematic diagram of structure illustrating an object determining module in FIG. 7;

FIG. 10 is another schematic diagram of structure illustrating an object determining module in FIG. 7; and

FIG. 11 is a structure schematic for an electronic device for query recommendation according to an exemplary embodiment of the present disclosure.

### DETAILED DESCRIPTION

Exemplary embodiments are illustrated in detail herein, with examples indicated in drawings. Where the following descriptions involve drawings, unless specially indicated, a same number in different drawings indicates the same or similar element. The implementing methods described in the following exemplary embodiments do not represent all implementing methods consistent with the present disclosure. On the contrary, they are merely examples of devices and methods consistent with some aspects of the present disclosure, as expatiated in the appended claims.

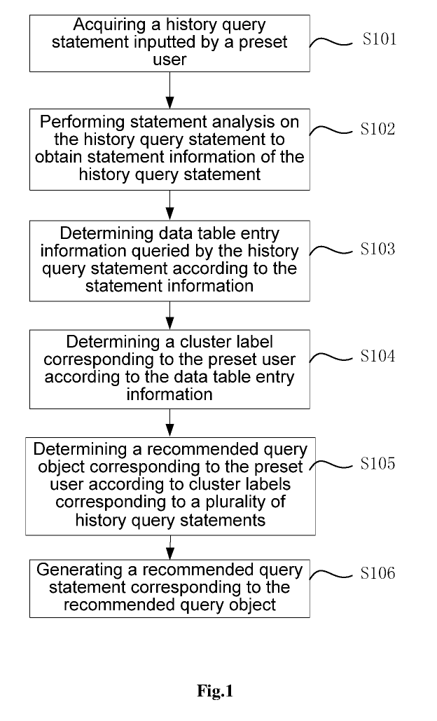

FIG. 1 is a flowchart illustrating a method for query recommendation provided according to an exemplary embodiment. As shown in FIG. 1, the method for query recommendation may include the following steps.

Step S101: a history query statement inputted by a preset user may be acquired.

In the embodiments of the present disclosure, there are many methods for acquiring a history query statement, and in one case, the user has inputted many history statements, then the step herein may include:

all history query statements corresponding to the preset user may be searched for from a history query record.

In specific application, a route to a preset history record may be firstly searched to find all history query statements, and then the history query statement corresponding to the user is screened from the history record according to username or other flags of the user.

In another case, every time the user inputs a query statement, the query statement may be directly taken as a history query statement. Compared with the previous method, this method is superior to be more real-time and quick, then the step herein may include:

a query statement inputted by the user may be taken as the history query statement.

For a database in different structures, when the user inputs a query statement, a format of the obtained history query statement may be required to be consistent with that of the queried database, in such a way it can be ensured that the corresponding data is searched for from the database using the history query statement.

Step S102: statement analysis may be performed on the history query statement to obtain statement information of the history query statement.

Referring to the above description associated with step S101, a format of the history query statement may be required to be consistent with that of the queried database, then in the step, the history query statement may be analyzed according to the corresponding format, and no matter which format of the database, the rule of the query statement is specified, in other words, contents included in the query statement are specified. For example:

The query statement is: select deptNo, deptName, sales, and score from dept;

Herein, “select” is a query action, which indicates to select; the subsequent “deptNo, deptName, sales, and score” indicate the contents to be queried; and “from dept” indicates a queried position.

It can be seen that, by analyzing the query statement, it can be known that statement information of the query statement is: selecting several parameters“deptNo, deptName, sales and score” from “dept”.

Step S103: data table entry information queried by the history query statement may be determined according to the statement information.

In the embodiments of the present disclosure, the data table entry information may include: a query object, a flag of a data table where the query object is located, and attribute information of the query object in the data table.

Herein, the query object refers to queried data, for example: age of one person, company of a second person, or commodity purchased by a third person in some shopping mall, and the like. Data queried by the user is usually in a data table, thus in data query, a flag of the data table where the data is located and a location where the data is located in the data table may be required to be obtained. In the embodiments of the present disclosure, attribute information refers to a location where data is located in a table, for example: row and column, field and the like.

Taking the table below as an example:

TABLE 1

| deptNo | deptName | sales | score |
|---|---|---|---|
| d001 | Sales dept. | 10000 | 1.2 |
| d002 | Human | 5000 | 0.9 |
| | resources | | |
| | dept. | | |
| d003 | Purchasing | 8000 | 1.1 |
| | dept. | | |
| d004 | Information | 7000 | 1.0 |
| | dept. | | |

Herein, if it is score status of Human resources dept. that is queried, the query object is “0.9”, the flag of the data table is “table 1”, wherein attribute information of “0.9” in the data table is: row 2, column 4.

Step S104: a cluster label corresponding to the preset user may be determined according to the data table entry information.

When the data table entry information of a query object is determined, the query object can be positioned according to these correlations, for example: the query object is: Letv Network Science and Technology Co., Ltd., and query content corresponding to Letv Network Science and Technology Co., Ltd. is an internet company located in Beijing, then it can be determined that the contents interesting the preset user are: “location is in Beijing” and “internet company”. Thus, a label of the user can be determined to be “internet company in Beijing” according to the query this time for defining the user, in such a way the user can be finally defined to be with many labels through numerous query statements, then the user can be accurately positioned through these labels.

Step S105: a recommended query object corresponding to the preset user may be determined according to cluster labels corresponding to a plurality of history query statements.

When a recommended query object of the user is determined, it can be judged simply according to frequentness of a label, for example: if the user queries a label of “internet company in Beijing” at most, all the Beijing internet companies can be taken as recommended query objects of the user, in other words, in a next query of the user, a probability of querying internet companies in Beijing for the user would be the most.

Of course, in other embodiments, a correlation of frequentness of a label in conjunction with the label may further be calculated more complicatedly to obtain a recommended query object with higher accuracy.

Step S106: a recommended query statement corresponding to the recommended query object may be generated.

After a recommended query object is determined, a recommended query statement may be directly generated according to rules such as lexics, syntax and semantics of the query statement, in such a way in a next query of the user, the recommended query statement may be directly recommended to the user, then the user may directly select the recommended query statement, rather than typing the query statement letter by letter on the keyboard, thus the query efficiency is improved.

According to the method provided the embodiments of the present disclosure, after a history query statement formerly inputted by a user is obtained, statement analysis may be performed on the history query statement to find statement information corresponding to the query statement; then data table entry information queried by the history query statement may be further obtained according to the found statement information, and one cluster label belonging to the user may be determined through these data table entry information and the user is defined at one time, and when the number of the query statement is great, it may be determined that one or more recommended query objects corresponding to the user can be finally obtained through cluster labels corresponding to numerous history query statements; and then a recommended query statement corresponding to the recommended query object may be generated.

By the above method, a reasoning analysis may be performed according to the history query statement of the user to find a query object mostly interesting the user, and a query statement corresponding to the recommended query object may be generated. In actual application, before the user inputs a query statement next time, the query statement may be displayed in a manner of a pop up or a pull-down menu, and correspondingly, the user only needs to click to finish an input of the statement, without need of typing each character or letter on the keyboard. In this way, the inputting efficiency of query statements is raised, and correspondingly, the efficiency of data query is also raised.

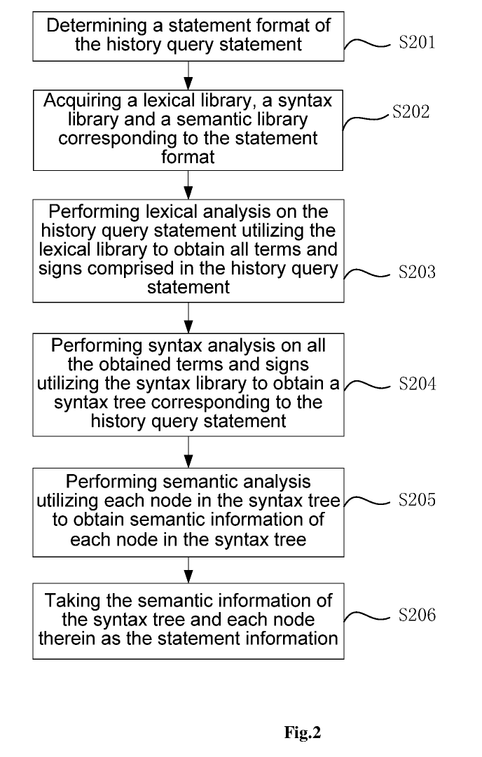

In another embodiment of the present disclosure, as shown in FIG. 2, step S102 shown in the embodiment of FIG. 1 may include the following steps.

Step S201: a statement format of the history query statement may be determined.

Statement formats of query statements may be different for different databases.

Step S202: a lexical library, a syntax library and a semantic library corresponding to the statement format may be acquired.

A lexical library, a syntax library and a semantic library corresponding to the statement format may be provided for different databases, so that the query statement can be analyzed after being acquired.

Step 203: lexical analysis may be performed on the history query statement utilizing the lexical library to obtain all terms and signs comprised in the history query statement.

In the embodiments of the present disclosure, a SQL (Structured Query Language) database is taken as an example, and illustrated below in combination with a specific example:

The above table 1 is a data table in data named “Dept”, which includes sales data and score status of different departments, wherein, deptNo, deptName, sales, and score are different columns in the table respectively, deptNo is number of department, deptName is name of department, sales is sales volume, and score is score.

In the step, by lexical analysis, in other words, by performing word segmentation on all characters in the history query statement, a phrase finally obtained includes: [select, deptNo, deptName, sales, score, from, dept] and the like.

Step S204: syntax analysis may be performed on all the obtained terms and signs utilizing the syntax library to obtain a syntax tree corresponding to the history query statement.

In the embodiments of the present disclosure, the syntax tree may include a plurality of nodes thereon.

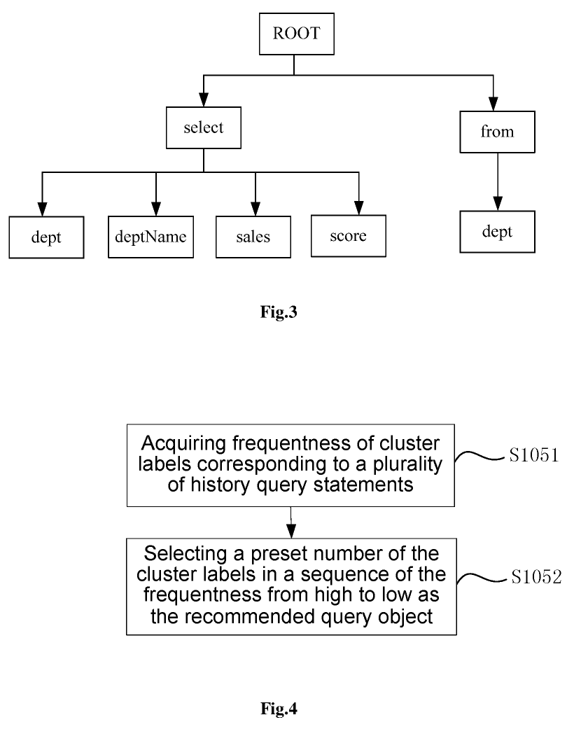

Referring to FIG. 3, it is a schematic diagram of structure illustrating the obtained syntax tree after analyzing the above query statement.

Step S205: semantic analysis may be performed on each node in the syntax tree to obtain semantic information of each node in the syntax tree.

As can be seen from FIG. 3, Root is root node, there are respective query instruction words below the root node, and then objects pointed to. By performing semantic analysis in the syntax tree, the meaning to be expressed by the history query statement, in other words, the statement information, can be obtained.

Step S206: the semantic information of the syntax tree and each node therein may be taken as the statement information.

In the embodiments of the present disclosure, character strings shown in FIG. 3 are those in some encoded codes, only as an example herein, rather than English characters. The encoding technician in the art can fully understand the meaning therein by reading the context, without need of separately explaining it one by one.

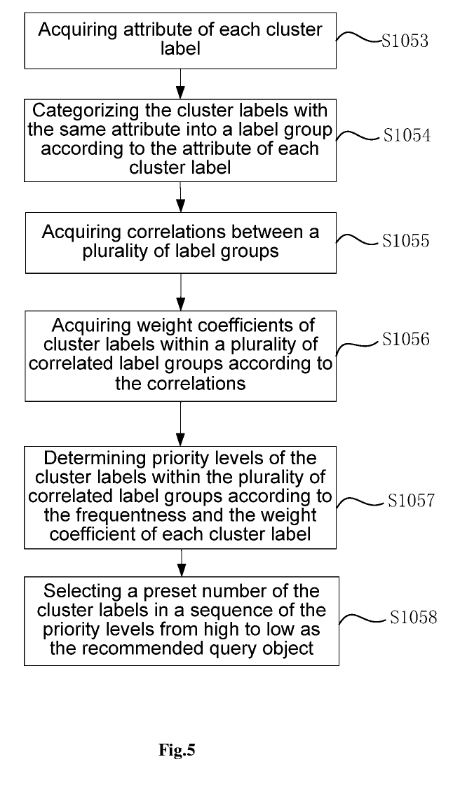

In another embodiment of the present disclosure, as shown in FIG. 4, step S105 shown in the embodiment of FIG. 1 may include the following steps.

Step S1051: frequentness of cluster labels corresponding to a plurality of history query statements may be acquired.

In the embodiments of the present disclosure, the frequentness refers to times a cluster label appears. In specific application, the frequentness can be denoted using Arabic numerals, for example: 101 or 202, etc. Furthermore, a ratio of times each label appears to times all labels appear can further be taken as the frequentness, for example: 20% or 5%.

Step S1052: a preset number of the cluster labels may be selected in a sequence of the frequentness from high to low as the recommended query object.

In the embodiments of the present disclosure, several cluster labels with the frequentness sequenced in front are taken as recommended query objects. In specific application, the preset number can be set in advance, and furthermore, the user may further set them randomly or arbitrarily depending on his or her own preference.

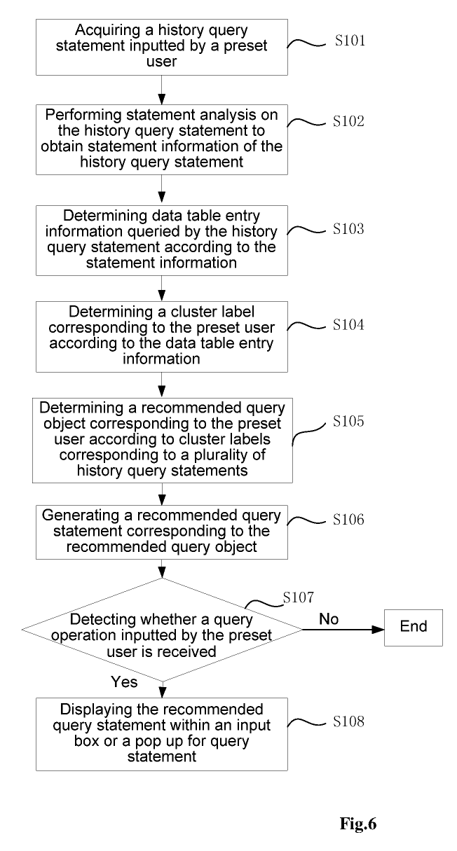

In another embodiment of the present disclosure, as shown in FIG. 5, step S105 shown in the embodiment of FIG. 1 may include the following steps.

Step S1053: attribute of each cluster label may be acquired.

The attribute of the label may be name of the label, for example: “Beijing”, “internet company”, “infants and pregnant goods”, “baby diapers”, “electronic products”, “mouse”, “laptop computer”, etc.

Step S1054: the cluster labels with the same attribute may be categorized into a label group according to the attribute of each cluster label.

In the embodiments of the present disclosure, it can be set in advance that which labels belong to a same class according to general knowledge, then in the step, the cluster labels with the same attribute can be categorized into a label group. For example: “electronic products”, “mouse”, “laptop computer”, “earphone”, etc. all belong to electronic products, thus can be categorized into a same label group. Correspondingly, “baby buggy”, “children educational toys”, “children books”, “milk powder”, “diaper” can all be categorized into a label group of “infants and pregnant goods”.

Each cluster label group may include at least one cluster label.

Step S1055: correlations between a plurality of label groups may be acquired.

In the embodiments of the present disclosure, the correlation refers to whether to be queried simultaneously in a same query statement. For example: the user queries “mouse” and “milk powder” in a same query statement, thus a correlation exists between “electronic products” and “infants and pregnant goods”.

The aforesaid distance is merely a simple correlation. Furthermore, in other embodiments, correlations between the label groups can further be determined according to times a same query statement appears. For example: the user queries “mouse” and “milk powder” in a query statement; queries “earphone” and “diaper” in another query statement; and queries “washing machine”, “children educational toys” and the like in a third query statement, and as can be seen from these statements, times the labels in two label groups appear in a same query statement can be counted, then a correlation may be determined between the two label groups if the counted times exceeds a preset times.

Step S1056: weight coefficients of cluster labels within a plurality of correlated label groups may be acquired according to the correlations.

In each label group, weight coefficients of different cluster labels can be set in advance, wherein the weight coefficient of a cluster label indicates the importance of the cluster label in the label group.

For example: taking “infants and pregnant goods” as an example, if a user searches for “milk powder”, it means that the user is bound to concern about “infants and pregnant goods”; and correspondingly, the weight coefficient of “milk powder” can be set higher. However, if the user searches for “baby oil”, then there is a possibility that an adult uses the product by oneself, in this case the weight coefficient of “baby oil” in “infants and pregnant goods” may be set lower.

Similarly, taking “computer product” as an example, if a user searches for “mouse”, it means that the user concerns more about “computer product”, thus the weight coefficient of “mouse” in “computer product” is higher; while if the user searches “earphone”, it means that the user may not concern about “computer product”, but be more likely to concern about earphone for mobile phone, and the like, thus the weight coefficient of “earphone” in computer product is lower.

Step S1057: priority levels of the cluster labels within the plurality of correlated label groups may be determined according to the frequentness and the weight coefficient of each cluster label.

In specific application, the frequentness of each cluster label can be multiplied by the weight coefficient thereof in each label group to obtain a product, then the product is taken as a priority level, in which way the priority levels of the cluster labels are sequenced.

Step S1058: a preset number of the cluster labels may be selected in a sequence of the priority levels from high to low as the recommended query object.

In specific application, a preset number of cluster labels are selected in a sequence of the priority levels from high to low respectively in two correlated label groups as the recommended query object. In this way in recommendation, contents in two data table entries can be simultaneously recommended, thereby raising the accuracy of recommendation.

In another embodiment of the present disclosure, as shown in FIG. 6, the method may further include the following steps.

Step S107: whether a query operation inputted by the preset user is received may be detected.

When a query operation inputted by the preset user is detected, step S108 is executed; otherwise the process is ended.

Step S108: the recommended query statement may be displayed within an input box or a pop up for query statement.

In actual application, before a user inputs a query statement next time, the query statement can be displayed in a manner of a pop up or a pull-down menu; and correspondingly, the user only needs to click to finish an input of the statement, without need of typing each character or letter on the keyboard. In this way, the inputting efficiency of query statements is raised, and correspondingly, the efficiency of data query is also raised.

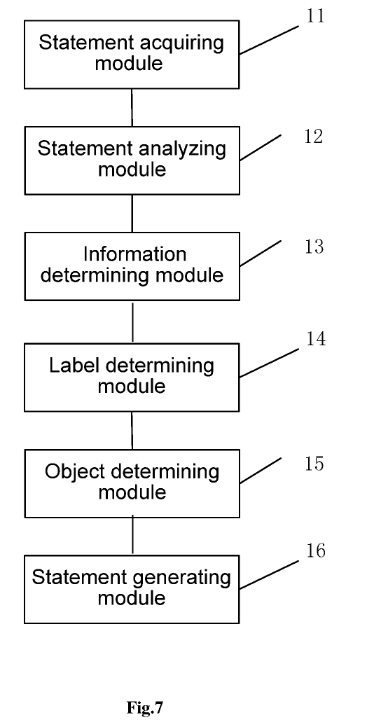

FIG. 7 is a schematic diagram of structure illustrating a device for query recommendation provided according to an exemplary embodiment. As shown in FIG. 7, the device for query recommendation may include:

a statement acquiring module 11, configured to acquire a history query statement inputted by a preset user;
a statement analyzing module 12, configured to perform statement analysis on the history query statement to obtain statement information of the history query statement;
an information determining module 13, configured to determine data table entry information queried by the history query statement according to the statement information, wherein the data table entry information includes: a query object, a flag of a data table where the query object is located, and attribute information of the query object in the data table;
a label determining module 14, configured to determine a cluster label corresponding to the preset user according to the data table entry information;
an object determining module 15, configured to determine a recommended query object corresponding to the preset user according to cluster labels corresponding to a plurality of history query statements; and
a statement generating module 16, configured to generate a recommended query statement corresponding to the recommended query object.

In another embodiment of the present disclosure, the aforesaid statement acquiring module 11 may include:

a statement searching submodule, configured to search for all history query statements corresponding to the preset user from a history query record.

In another embodiment of the present disclosure, the aforesaid statement acquiring module 11 may include:

a statement determining submodule, configured to take a query statement inputted by the user as the history query statement.

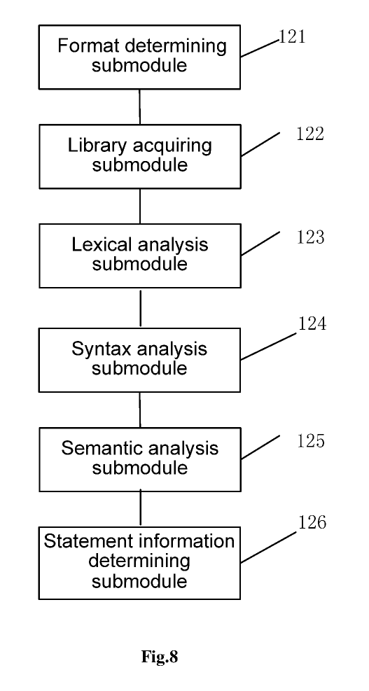

In another embodiment of the present disclosure, as shown in FIG. 8, the aforesaid statement analyzing module 12 may include:

a format determining submodule 121, configured to determine a statement format of the history query statement;
a library acquiring submodule 122, configured to acquire a lexical library, a syntax library and a semantic library corresponding to the statement format;
a lexical analysis submodule 123, configured to perform lexical analysis on the history query statement utilizing the lexical library to obtain all terms and signs included in the history query statement;
a syntax analysis submodule 124, configured to perform syntax analysis on all the obtained terms and signs utilizing the syntax library to obtain a syntax tree corresponding to the history query statement, wherein the syntax tree includes a plurality of nodes;
a semantic analysis submodule 125, configured to perform semantic analysis on each node in the syntax tree to obtain semantic information of each node in the syntax tree; and
a statement information determining submodule 126, configured to take the semantic information of the syntax tree and each node therein as the statement information.

In another embodiment of the present disclosure, as shown in FIG. 9, the aforesaid object determining module 15 may include:

a frequentness acquiring submodule 151, configured to acquire frequentness of cluster labels corresponding to a plurality of history query statements; and
a first object determining submodule 152, configured to select a preset number of the cluster labels in a sequence of the frequentness from high to low as the recommended query object.

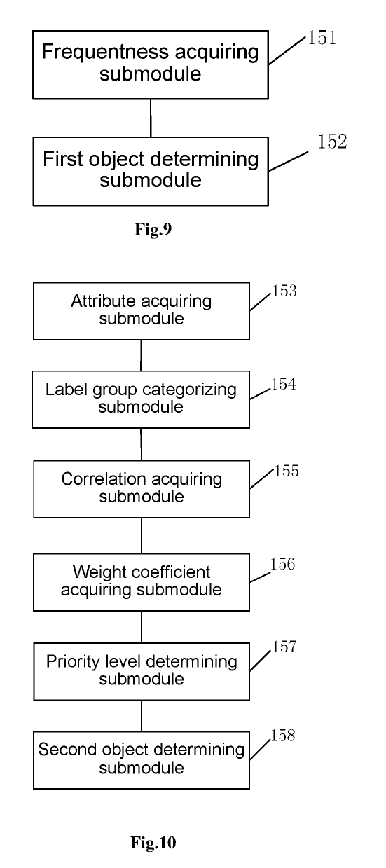

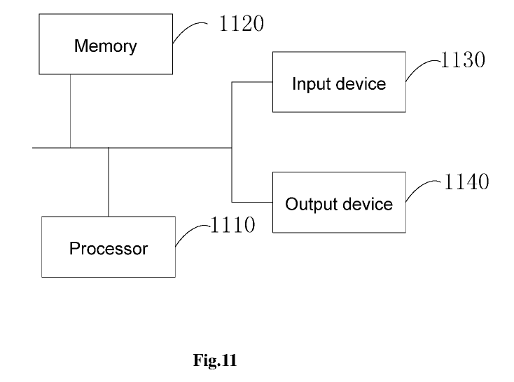

In another embodiment of the present disclosure, as shown in FIG. 10, the aforesaid object determining module 15 may include:

an attribute acquiring submodule 153, configured to acquire attribute of each cluster label;
a label group categorizing submodule 154, configured to categorize the cluster labels with the same attribute into a label group according to the attribute of each cluster label, wherein each cluster label group includes at least one cluster label;
a correlation acquiring submodule 155, configured to acquire correlations between a plurality of label groups;
a weight coefficient acquiring submodule 156, configured to acquire weight coefficients of cluster labels within a plurality of correlated label groups according to the correlations;
a priority level determining submodule 157, configured to determine priority levels of the cluster labels within the plurality of correlated label groups according to the frequentness and the weight coefficient of each cluster label; and
a second object determining submodule 158, configured to select a preset number of cluster labels in a sequence of the priority levels from high to low as the recommended query object.

In another embodiment of the present disclosure, the device shown in FIG. 7 may further include:

an operation detecting module, configured to detect whether a query operation inputted by the preset user is received; and

a statement displaying module, configured to display the recommended query statement within an input box or a pop up for query statement when the query operation inputted by the preset user is detected.

The embodiments of the present disclosure may further provide a device for query recommendation, including:

a processor;
a memory device, configured to store instructions executable by the processor;
wherein, the processor is configured to:
acquire a history query statement inputted by a preset user;
perform statement analysis on the history query statement to obtain statement information of the history query statement;
determine data table entry information queried by the history query statement according to the statement information, wherein the data table entry information includes: a query object, a flag of a data table where the query object is located, and attribute information of the query object in the data table;
determine a cluster label corresponding to the preset user according to the data table entry information;
determine a recommended query object corresponding to the preset user according to cluster labels corresponding to a plurality of history query statements; and generate a recommended query statement corresponding to the recommended query object.

The embodiments of the present disclosure may further provide a non-volatile computer readable storage medium that is stored with computer executable instructions configured to perform a method for query recommendation provided according to any one of the above method embodiments.

FIG. 11 is a hardware structure schematic illustrating an electronic device for query recommendation according to embodiments of the present disclosure. As shown in FIG. 11, the electronic device may comprise the following components.

One or more processor 1110 and a memory 1120 may be included. In FIG. 11, one processor 1110 may be taken as an example.

The input device 1130 and the output device 1140 may be further included.

The processor 1110, the memory 1120, the input device 1130 and the output device 1140 may be connected with each other through bus connection or other means. In FIG. 11, bus connection is taken as an example.

The memory 1120, as non-volatile computer readable storage medium, may be configured to be stored with non-volatile software program, non-volatile computer executable program and modules such as program instructions/modules according to the method for query recommendation of the embodiments of the present disclosure (such as modules illustrated in FIG. 7˜FIG. 10). The processor 1110 may perform various functional applications and data processing of the server by executing non-volatile software program, instructions and modules stored in the memory 1120, to implement the method for query recommendation according to the embodiments of the present disclosure.

The memory 1120 may include a program storage area and a data storage area, wherein, the program storage area may be configured to be stored with an operating system and application for at least one function, and the data storage area may be stored with data created during the use of the device for query recommendation. Further, the memory 1120 may include a high-speed random access memory, and/or non-volatile memory, such as at least one magnetic disk storage device, flash memory device, or other non-volatile solid-state memory device. In some embodiments, the memory 1120 may include a memory remotely provided with respect to the processor 1110, which may be connected to the device for query recommendation through network connections, including but not limited to the internet, intranet, Local Area Network, mobile communication network and combinations thereof.

The input device 1130 may receive inputted information such as numbers or characters, and generate key signal input involving the user settings of the device for query recommendation and functional control. The output device 1140 may include a display device such as a display screen.

The one or more modules may be stored in the memory 1120, which, when executed by the at least one processor 1110, implements the method for query recommendation according to any one of the above method embodiments.

The above electronic device may perform the method provided by the embodiments of the present disclosure, have the corresponding functional modules and advantageous effects. The details which are not described in detail, may be referred to the method embodiments of the present disclosure.

The electronic device of the embodiments of the present disclosure may be in various forms, including but not limited to:

(1) mobile communication device: this type of device has mobile communication function, and is configured mainly for voice and data communication, including smart phone (iPhone), multi-media phone, functional phone and conventional phone.

(2) ultra-mobile personal computer device: a type of personal computer, having functions of calculation and processing, and mobile internet service, including, PDA, MID, and UMPC device, such as iPad.

(3) portable entertainment device: this type of device may display and play multi-media content, including a audio/video player (such as iPod), handheld game player, e-book, and smart toy and portable vehicle navigation device.

(4) server: a type of device providing computational service, including a processor, a hard disk, a memory, and a system bus, which has a similar frame as a general computer, and has a higher requirement in processability, stability, reliability, safety, extendibility, and manageability.

(5) Other electronic devices having data interaction function.

The above-described device embodiments are only illustrative, wherein the components illustrated as separate may be or may be not physically separate, and the components displayed as units may be or may be not physical units, which may be located in one place or distributed over a plurality of network units. Some or all of the modules of the electronic device may be selected to be executed according to practical needs.

By the description of above method embodiments, one skilled in the art may clearly know that the present disclosure may be achieved by virtue of software plus necessary general hardware platforms, of course, it may also be achieved by hardware. Based on such an understanding, the technical solution of the present disclosure in essence or the part contributing to the prior art may be presented in the form of a software product. The computer software product may be stored in a storage medium (such as ROM/RAM, magnetic disk and optical disk, etc.), containing some instructions to enable a computer device (such as a personal computer, a server, or network device and etc.) to perform some or all of steps of the method mentioned in each of the embodiments of the present disclosure.

Finally, the above embodiments are only for illustrating the embodiments of the present disclosure, rather than limiting it. Although the present disclosure has been described in detail with reference to the above embodiments, a person of ordinary skill in the art may understand that, various changes, variations, or equivalent substitutions may be made to the above embodiments without departing from the spirit and scope of the present disclosure.

What is claimed is:

1. A method for query recommendation, applied to a server, comprising:
acquiring a history query statement inputted by a preset user;
performing statement analysis on the history query statement to obtain statement information of the history query statement;
determining data table entry information queried by the history query statement according to the statement information, wherein the data table entry information comprises: a query object, a flag of a data table where the query object is located, and attribute information of the query object in the data table;
determining a cluster label corresponding to the preset user according to the data table entry information;
determining a recommended query object corresponding to the preset user according to cluster labels corresponding to a plurality of history query statements; and
generating a recommended query statement corresponding to the recommended query object.

2. The method according to claim 1, wherein, the acquiring a history query statement inputted by a preset user, comprises:
searching for all history query statements corresponding to the preset user from a history query record;
or,
taking a query statement inputted by the user as the history query statement.

3. The method according to claim 1, wherein, the performing statement analysis on the history query statement to obtain statement information of the history query statement, comprises:
determining a statement format of the history query statement;
acquiring a lexical library, a syntax library and a semantic library corresponding to the statement format;
performing lexical analysis on the history query statement utilizing the lexical library to obtain all terms and signs comprised in the history query statement;
performing syntax analysis on all the obtained terms and signs utilizing the syntax library to obtain a syntax tree corresponding to the history query statement, wherein the syntax tree comprises a plurality of nodes;
performing semantic analysis utilizing each node in the syntax tree to obtain semantic information of each node in the syntax tree; and
taking the semantic information of the syntax tree and each node therein as the statement information.

4. The method according to claim 1, wherein, the determining a recommended query object corresponding to the preset user according to cluster labels corresponding to a plurality of history query statements, comprises:
acquiring frequentness of cluster labels corresponding to a plurality of history query statements; and
selecting a preset number of the cluster labels in a sequence of the frequentness from high to low as the recommended query object.

5. The method according to claim 4, wherein, the determining a recommended query object corresponding to the preset user according to cluster labels corresponding to a plurality of history query statements, comprises:
acquiring attribute of each cluster label, and categorizing the cluster labels with the same attribute into a label group according to the attribute of each cluster label, wherein each cluster label group comprises at least one cluster label;
acquiring correlations between a plurality of label groups;
acquiring weight coefficients of cluster labels within a plurality of correlated label groups according to the correlations;
determining priority levels of the cluster labels within the plurality of correlated label groups according to the frequentness and the weight coefficient of each cluster label; and
selecting a preset number of cluster labels in a sequence of the priority levels from high to low as the recommended query object.

6. The method according to claim 1, wherein, the method further comprises:
detecting whether a query operation inputted by the preset user is received; and
displaying the recommended query statement within an input box or a pop up for query statement when the query operation inputted by the preset user is detected.

7. A non-volatile computer readable storage medium that is stored with computer executable instructions configured to perform the following:
acquiring a history query statement inputted by a preset user;
performing statement analysis on the history query statement to obtain statement information of the history query statement;
determining data table entry information queried by the history query statement according to the statement information, wherein the data table entry information comprises: a query object, a flag of a data table where the query object is located, and attribute information of the query object in the data table;
determining a cluster label corresponding to the preset user according to the data table entry information;
determining a recommended query object corresponding to the preset user according to cluster labels corresponding to a plurality of history query statements; and
generating a recommended query statement corresponding to the recommended query object.

8. The non-volatile computer readable storage medium according to claim 7, wherein, the acquiring a history query statement inputted by a preset user, comprises:
searching for all history query statements corresponding to the preset user from a history query record;
or,
taking a query statement inputted by the user as the history query statement.

9. The non-volatile computer readable storage medium according to claim 7, wherein, the performing statement analysis on the history query statement to obtain statement information of the history query statement, comprises:
determining a statement format of the history query statement;
acquiring a lexical library, a syntax library and a semantic library corresponding to the statement format;
performing lexical analysis on the history query statement utilizing the lexical library to obtain all terms and signs comprised in the history query statement;
performing syntax analysis on all the obtained terms and signs utilizing the syntax library to obtain a syntax tree corresponding to the history query statement, wherein the syntax tree comprises a plurality of nodes;
performing semantic analysis utilizing each node in the syntax tree to obtain semantic information of each node in the syntax tree; and
taking the semantic information of the syntax tree and each node therein as the statement information.

10. The non-volatile computer readable storage medium according to claim 7, wherein, the determining a recommended query object corresponding to the preset user according to cluster labels corresponding to a plurality of history query statements, comprises:
acquiring frequentness of cluster labels corresponding to a plurality of history query statements; and
selecting a preset number of the cluster labels in a sequence of the frequentness from high to low as the recommended query object.

11. The non-volatile computer readable storage medium according to claim 10, wherein, the determining a recommended query object corresponding to the preset user according to cluster labels corresponding to a plurality of history query statements, comprises:
acquiring attribute of each cluster label, and categorizing the cluster labels with the same attribute into a label group according to the attribute of each cluster label, wherein each cluster label group comprises at least one cluster label;
acquiring correlations between a plurality of label groups;
acquiring weight coefficients of cluster labels within a plurality of correlated label groups according to the correlations;
determining priority levels of the cluster labels within the plurality of correlated label groups according to the frequentness and the weight coefficient of each cluster label; and
selecting a preset number of cluster labels in a sequence of the priority levels from high to low as the recommended query object.

12. The non-volatile computer readable storage medium according to claim 7, wherein, the computer executable instructions are further configured to perform:
detecting whether a query operation inputted by the preset user is received; and
displaying the recommended query statement within an input box or a pop up for query statement when the query operation inputted by the preset user is detected.

13. An electronic device, comprising:
at least one processor; and
a memory communicatively connected to the at least one processor, wherein
the memory is stored with instructions executable by the at least one processor, which, when executed by the at least one processor, enable the at least one processor to perform the following:
acquiring a history query statement inputted by a preset user;
performing statement analysis on the history query statement to obtain statement information of the history query statement;
determining data table entry information queried by the history query statement according to the statement information, wherein the data table entry information comprises: a query object, a flag of a data table where the query object is located, and attribute information of the query object in the data table;
determining a cluster label corresponding to the preset user according to the data table entry information;
determining a recommended query object corresponding to the preset user according to cluster labels corresponding to a plurality of history query statements; and
generating a recommended query statement corresponding to the recommended query object.

14. The electronic device according to claim 13, wherein, the acquiring a history query statement inputted by a preset user, comprises:
searching for all history query statements corresponding to the preset user from a history query record;
or,
taking a query statement inputted by the user as the history query statement.

15. The electronic device according to claim 13, wherein, the performing statement analysis on the history query statement to obtain statement information of the history query statement, comprises:
determining a statement format of the history query statement;
acquiring a lexical library, a syntax library and a semantic library corresponding to the statement format;
performing lexical analysis on the history query statement utilizing the lexical library to obtain all terms and signs comprised in the history query statement;
performing syntax analysis on all the obtained terms and signs utilizing the syntax library to obtain a syntax tree corresponding to the history query statement, wherein the syntax tree comprises a plurality of nodes;
performing semantic analysis utilizing each node in the syntax tree to obtain semantic information of each node in the syntax tree; and
taking the semantic information of the syntax tree and each node therein as the statement information.

16. The electronic device according to claim 13, wherein, the determining a recommended query object corresponding to the preset user according to cluster labels corresponding to a plurality of history query statements, comprises:
acquiring frequentness of cluster labels corresponding to a plurality of history query statements; and
selecting a preset number of the cluster labels in a sequence of the frequentness from high to low as the recommended query object.

17. The electronic device according to claim 16, wherein, the determining a recommended query object corresponding to the preset user according to cluster labels corresponding to a plurality of history query statements, comprises:
acquiring attribute of each cluster label, and categorizing the cluster labels with the same attribute into a label group according to the attribute of each cluster label, wherein each cluster label group comprises at least one cluster label;
acquiring correlations between a plurality of label groups;
acquiring weight coefficients of cluster labels within a plurality of correlated label groups according to the correlations;
determining priority levels of the cluster labels within the plurality of correlated label groups according to the frequentness and the weight coefficient of each cluster label; and
selecting a preset number of cluster labels in a sequence of the priority levels from high to low as the recommended query object.

18. The electronic device according to claim 13, wherein, the at least one processor is further configured to perform:
detecting whether a query operation inputted by the preset user is received; and
displaying the recommended query statement within an input box or a pop up for query statement when the query operation inputted by the preset user is detected.
